(19) United States
(12) Patent Application Publication
(10) Pub. No.: US 2026/0141316 A1
(43) Pub. Date: May 21, 2026

(54) PROGRAM, INFORMATION PROCESSING METHOD, AND TERMINAL

(71) Applicant: LY CORPORATION, Tokyo (JP)

(72) Inventors: Hiromu ARIGA, Tokyo (JP); Kei WAKABAYASHI, Tokyo (JP); Kazuki MATSUMOTO, Tokyo (JP); Takayuki YAMAMOTO, Tokyo (JP); Amane MUKAI, Tokyo (JP)

(73) Assignee: LY CORPORATION, Tokyo (JP)

(21) Appl. No.: 19/393,853

(22) Filed: Nov. 19, 2025

(30) Foreign Application Priority Data
Nov. 19, 2024 (JP) 2024-201359

(51) Int. Cl. G06Q 10/02; H04L 51/02

(52) U.S. Cl. CPC G06Q 10/02; H04L 51/02

(57) ABSTRACT

A program to be executed by a terminal causes the terminal to: display, with a chat application, an itinerary and an object related to a service based on the itinerary on a display of the terminal; and in response to the service being reserved through a reservation service linked to a chat service of the chat application based on an input made with respect to the object by a user of the terminal, display reservation information regarding the reservation of the service made through the reservation service on the display, with the chat application.

### CROSS-REFERENCE TO RELATED APPLICATIONS

This application claims priority under 35 U.S.C. § 119 to Japanese Patent Application No. 2024-201359, filed on Nov. 19, 2025, in the Japanese Property Office (JPO), the entire contents of which are incorporated herein by reference.

### BACKGROUND

The present disclosure relates to a program, an information processing method, a terminal, and/or the like.

A user may plan to travel and plan an itinerary. Conventional travel planning may be inconvenient. For example, conventionally, travel planning and service reservations may require users to navigate multiple disparate applications and platforms, often leading to fragmented workflows and inefficiencies. For instance, a user might generate an itinerary using a dedicated travel planning tool or website, then separately search for related services such as accommodations or dining options via search engines or specialized apps, and finally switch to yet another reservation service to book those services. This siloed approach may not only require a user to perform excessive context switching between interfaces, increasing the risk of errors and user frustration, but may also consume additional device resources and network bandwidth due to repeated data loading and redundant inputs, ultimately prolonging the overall process and diminishing the user experience.

### SUMMARY

At least some example embodiments are directed to a non-transitory computer readable medium storing a program that, when executed by a terminal, causes the terminal to: display, within a chat application displayed on the terminal, an itinerary and an object related to a service based on the itinerary, wherein the object includes a link to a page integrated within the chat application that facilitates a reservation service; and display, within the chat application, reservation information regarding a reservation of the service made by a user of the terminal through the reservation service on the display.

In some example embodiments, the program, when executed, further causes the terminal to: instruct a server to generate the itinerary based on a conversation within a talk room of the chat application between the user of the terminal and a chatbot; and receive the itinerary from the server communicatively coupled to the terminal.

In some example embodiments, the program, when executed, further causes the terminal to generate the reservation information such that the reservation information includes a reservation completion page integrated within the chat application, the reservation completion page indicating that the reservation of the service is complete.

In some example embodiments, the program, when executed, further causes the terminal to: retrieve objects respectively related to a plurality of services based on the itinerary, the objects including a first object related to a first service provided by a sponsor, and display the reservation information on the display based on the first service being reserved through the reservation service based on an input made with respect to the first object by the user of the terminal.

In some example embodiments, the reservation information includes information indicating that a cost of the first service has been reduced.

In some example embodiments, the object is displayed inside or outside a display area for the itinerary.

In some example embodiments, the itinerary is a first itinerary and the object is a first object, and wherein the program, when executed by the terminal, further causes the terminal to: change the first itinerary to a second itinerary and the first object to a second object based on an input for changing the first object made by the user of the terminal, and display, within the chat application on the display, the second itinerary, and the second object.

In some example embodiments, the first object is a first advertisement, and the second object is a second advertisement different from the first advertisement, or a non-advertisement object.

In some example embodiments, the program, when executed by the terminal, further causes the terminal to: transmit, to a server communicatively coupled to the terminal, a change request based on the input for changing the first object; and receive, from the server, the second itinerary and the second object, in response to transmitting the change request.

In some example embodiments, the server changes the first itinerary to the second itinerary while maintaining the reservation of the service based on an unchangeability flag being set for the service.

In some example embodiments, the program, when executed by the terminal, further causes the terminal to: display the itinerary on a map within a talk room; and display the object related to the service on the map.

In some example embodiments, the program, when executed by the terminal, further causes the terminal to: perform account linkage processing to link an account of the user in the chat application with an account of the user in the reservation service; and display, within the chat application, account linkage completion information indicating completion of the account linkage.

In some example embodiments, the program, when executed by the terminal, further causes the terminal to: perform the reservation using the account linked to the reservation service without transitioning to an external application.

In some example embodiments, the program, when executed by the terminal, further causes the terminal to: calculate a position of the terminal using a position detector; and transmit the position of the terminal to a server such that the itinerary is tailored to the position of the terminal.

Some example embodiments are directed to an information processing method performed by a terminal, the method including displaying, within a chat application displayed on the terminal, an itinerary and an object related to a service based on the itinerary, wherein the object includes a link to a page integrated within the chat application that facilitates a reservation service; and displaying, within the chat application, reservation information regarding a reservation of the service made by a user of the terminal through the reservation service.

Some example embodiments are directed to a terminal including a display; and a processor and a memory storing a program that, when executed by the processor, causes the terminal to: display, within a chat application displayed on the display, an itinerary and an object related to a service based on the itinerary, wherein the object includes a link to a page integrated within the chat application that facilitates a reservation service, and display, within the chat application, reservation information regarding a reservation of the service made by a user of the terminal through the reservation service.

### BRIEF DESCRIPTION OF THE DRAWINGS

FIG. 1 shows an example of a system configuration of a communication system according to an example embodiment.

FIG. 2 shows an example of a function implemented by a controller of a server according to the example embodiment.

FIG. 3 shows an example of information stored in a storage of the server according to the example embodiment.

FIG. 4 shows an example of account registration data according to the example embodiment.

FIG. 5 shows an example of a function implemented by a controller of a terminal according to the example embodiment.

FIG. 6 shows an example of information stored in a storage of the terminal according to the example embodiment.

FIG. 7 shows examples of screens appearing on a display of the terminal according to the example embodiment.

FIG. 8 shows examples of screens appearing on the display of the terminal according to the example embodiment.

FIG. 9 is a flowchart illustrating an example of a processing flow performed by each device according to the example embodiment.

### DETAILED DESCRIPTION

### Compliance With Legal Requirements

It should be noted that the disclosure provided herein is premised on compliance with legal requirements, such as secrecy of communication, in the country in which the present disclosure is to be implemented.

### Example Embodiments

Note that the phrase “for example” is used in some parts of the present specification for ease of understanding, while it should be noted that not only those parts but the entirety of the following embodiments is not limited to the content described therein.

The following describes embodiments for implementing a program and the like according to the present disclosure, with reference to the drawings.

The production of a terminal according to example embodiment may include, for example, a concept that a state in which the functions are achieved on the terminal owned (carried) by a user as a result of this terminal receiving (or receiving and storing) a program (e.g., an application program) or the like described herein.

Also, the production of a system according to example embodiments may include, for example, a concept that a state in which the functions of the system are achieved as a result of a terminal included in the system of the present application receiving a program (e.g., an application program) or the like described herein that is transmitted from a server included in the system (or as a result of the received program being stored in the terminal).

As used herein, the term “system” may include a plurality of devices, for example.

The plurality of devices may be a combination of devices of the same type, a combination of devices of different types, or a combination of devices of the same type and devices of different types.

Note that, for example, the system can also be considered as performing certain processing with the plurality of devices cooperating with each other.

The term “a system related to a client (client device) and a server” may be, for example, considered as at least one of the following cases:
(1) a terminal and a server;
(2) a server; and
(3) a terminal.

In the case (1), the system includes, for example, at least one terminal and at least one server. The system in this example is a client-server system.

The server is constituted by, for example, the following devices, which may be a single device or a combination of a plurality of devices.

Specifically, the server may have, for example, any one or more of the following: a processor (e.g., a central processing unit (CPU), a graphics processing unit (GPU), an accelerated processing unit (APU), a digital signal processor (DSP; e.g., an application specific integrated circuit (ASIC), a field programmable gate array (FPGA) etc.), a computer device (a processor and a memory), a control device, an arithmetic device, and a processing unit. The server may include two or more of any one of the above devices of the same type (e.g., two CPUs, a homogeneous multi-core processor etc.) or include two or more of any one of the above devices of different types (e.g., a CPU and a DSP, a heterogeneous multi-core processor etc.), or may be a combination of two or more devices (e.g., a processor and a computer device, a processor and an arithmetic device, a heterogeneous configuration of two or more devices, etc.).

Note that the processor may be a virtual processor.

When the server constituted by a single device performs a certain type of processing, the single device performs the processing described in the example embodiments. If the server is constituted by a plurality of devices, some of the devices may perform one part of the processing and another device may perform the other part of the processing. For example, if the server includes a processor and an arithmetic device, the processor may perform first processing and the arithmetic device may perform second processing.

If the server includes a plurality of devices, the devices may be disposed at physically separated locations.

Functions of the server may be provided, for example, in the form of PaaS, IaaS, or SaaS in cloud computing.

A controller of the system can be at least either a controller of the terminal or a controller of the server. That is, for example, any of the following can be the controller of the system: (1A) only the controller of the terminal; (1B) only the controller of the server; and (1C) both the controller of the terminal and the controller of the server.

Control and processing (hereinafter collectively referred to as “control and the like”) performed by the controller of the system may be: (1A) performed solely by the controller of the terminal; (1B) performed solely by the controller of the server; or (1C) performed by both the controller of the terminal and the controller of the server.

In the case (1C), for example, part of control and the like performed by the controller in the system may be performed by the controller of the terminal, and the remainder of the control and the like may be performed by the controller of the server. In this case, the allocation of the control and the like may be equal or different from the equal allocation.

If the server is constituted by a single apparatus, the term “a communication device of the server” may refer to a communication device included in the single apparatus. If the server includes a plurality of devices, the communication device of the server may include communication devices included in the respective devices.

For example, if the server includes a first device and a second device, the first device has a first communication device, and the second device has a second communication device, the term “a communication device of the server” may refer to a concept that includes the first communication device and the second communication device.

In the case (2), the system may include, for example, a plurality of servers (hereinafter referred to as a “server system”). In this case, the aforementioned configuration can be similarly applied to each of the servers.

Control and the like performed by the server system may be performed by: (2A) only one of the plurality of servers; (2B) only another one of the servers; or (2C) one server and another server out of the plurality of servers.

In the case (2C), for example, part of control and the like performed by the server system may be performed by one server, and the remainder of the control and the like may be performed by another server. In this case, the allocation of the control and the like may be equal or different from the equal allocation.

In the case (3), the system may include, for example, a plurality of terminals.

This system may be, for example, as follows:
a system in which terminals have server functions (distributed system), which can be implemented, for example, by using a blockchain technology; or
a system in which terminals wirelessly communicate with each other, which can be implemented, for example, by performing communication in a P2P (peer-to-peer) method using a short-range wireless communication technology, such as Bluetooth (registered trademark).

Note that the above description is not limited to the controller, but also applies to functional parts such as input/output devices, communication devices, storages, and clocks that can be constituent elements of the system.

In the following embodiments, for example, a system that includes terminals and a server (e.g., a client-server system) will be illustrated.

Note that the server system in the above case (2) can also be applied as the server.

Instead of the system that includes terminals and a server, for example, the system in the above case (3) can be applied as a system that does not include a server.

An embodiment in this case can be configured based on the aforementioned blockchain technology or the like. Specifically, for example, data stored and managed in a server described in the following embodiments is kept (stored) on a blockchain. The terminal generates a transaction to the blockchain, and data kept on the blockchain can be updated upon the transaction being approved on the blockchain.

Note that, even when the term “terminal” is used, this is not limited to the meaning of a terminal as a client device in a client-server system.

That is, the term “terminal” may also include a concept of a device that is not included in a client-server system.

In the present specification, the expression “via a communication I/F” is used as appropriate. This expression means that, for example, a device may transmit and receive various types of information and data via the communication I/F (via a communication device) under the control of a controller (a processor, etc.).

Regarding the terms “related to” and “associated with” as used herein, “B related to A” and “B associated with A” may mean, for example, that B has a certain relationship with A.A specific example will be described later.

When a device performs processing targeting two or more objects, such as “transmitting A and B” or “receiving A and B” as used herein, the processing may be performed at the same time for A and B (hereinafter expressed as “synchronously”) or at different times for A and B (hereinafter expressed as “asynchronously”).

For example, when first information and second information are transmitted, this may include both concepts of transmitting the first information and the second information at the same time and transmitting the first information and the second information at different times.

Note that, considering a lag (time lag), “synchronously” may include “substantially synchronously”.

Note that, when processing is performed at different times for A and B, this need only means that the processing is performed targeting A and B, and the purpose need not necessarily be the same.

For example, when the first information and the second information are transmitted as mentioned above, the first information and the second information need only be transmitted, and this may include a case where the first information and the second information are transmitted for the same purpose, and a case where the first information and the second information are transmitted for different purposes.

In the following example embodiments, a messaging service is illustrated as an example of a service used by users to chat (hereinafter referred to as a “chat service”). An application for realizing the chat service is referred to as a “chat application”. An application for realizing the messaging service is referred to as a “messaging application”.

For example, the chat application enables users to chat in a chat room.

Note that the messaging service (MS; including an instant messaging service (IMS)) can also be considered as one form of a social networking service (social media platform). Thus, the messaging service and the social networking service may be, but need not necessarily be, distinguished from each other. That is, the social networking service may include the messaging service.

In the following example embodiments, an instant messaging service (IMS), in which simple messages are transmitted and received between a plurality of devices (e.g., terminals) via a server, will be illustrated as an example of a messaging service.

An instant messaging application enables users to talk in a talk room, for example.

A chat room (e.g., a talk room) may be a user interface (UI) or a graphical user interface (GUI) that enables each user to view content transmitted and received between terminals of a plurality of users.

A messaging service enables, for example, a user to exchange messages via a talk room by registering any account as a “friend”.

For example, a “friend” may be considered as the relationship between first and second users of the messaging application when the accounts of the first and second users are unidirectionally or bidirectionally associated.

For example, when the account of the first user and the account of the second user are mutually associated, the first and second users may be called “friends”. Also, for example, when the first user has associated their account with the account of the second user, the first and second users may be called “friends” even if the second user has not associated their account with the account of the first user.

Talk rooms may include, for example, a one-on-one user talk room (hereinafter referred to as a “one-on-one talk room”), a talk room for a group including a plurality of users (hereinafter referred to as a “group talk room”), a talk room for talking with an official account (OA) operator (e.g., a business operator partnered with the messaging service provider) (hereinafter referred to as an “OA talk room”).

An account of a messaging service (messaging application) that is an account of a business operator rather than a general user may be referred to as an “official account (OA),” and the user of the official account may be referred to as an “official user.” Note that this may also be referred to as an “official account user” or “official account operator”, for example.

Meanwhile, an account of a user that is an account on a messaging service and is not an OA operator is referred to as a “general account”, and a user with a general account is called a “general user”. Note that this may also be referred to as a “general account user”, for example.

That is, accounts for a messaging service may include general accounts and official accounts.

An OA operator may be able to, for example, transmit and receive messages to and from other devices via a server, using a terminal similar to a terminal of a user with a general account.

A message (message information) is, for example, information for which a transmission source and a transmission destination used in a messaging service are determined, and may be information constituted by identification information (a message ID) for identifying the message, and message content.

The message content may mean the content of a message excluding the message ID, for example. The message content may include one or more content items.

Information set as identification information for identifying a message is referred to as a “message ID”.

It can also be considered that the message content included in a message with the same message ID is identified by this message ID. Therefore, it can also be considered that the identification information for identifying a message has substantially the same meaning as the identification information for identifying the message content.

Note that, unlike this, individual identification information (message content IDs) may optionally be set for each message content item.

The term “content” may include, for example, text content in the form of text, image content in the form of images (including at least either a still image or a moving image), and sound content in the form of sound (including voice).

Note that the term “content” may also include operable content such as a button and an icon to be operated by the user, and link content such as a URI (including a URL etc.).

The term “text” may include, for example, at least one of characters of any country, extended characters, machine-dependent characters, numerals, symbols, graphics, and signs that are represented by character codes.

Note that the term “text” need not necessarily include at least one of the aforementioned characters, extended characters, machine-dependent characters, numerals, symbols, graphics, and signs, and may also include any other type of text.

The term “image” may include, for example, at least one of various types of image information such as an icon, a button, a stamp, an emoji, and a banner image.

Note that, unlike the above definitions, it may optionally be defined that “content” is a superordinate concept of a message, or that “content” and “message” have the same meaning.

The present embodiment will illustrate a technique for easily making a reservation related to a service included in an itinerary (itinerary information).

Here, the term “itinerary” (itinerary information) may include, for example, an activity plan in the case of traveling or moving. The term “itinerary” may include, for example, chronological and/or spatial designation elements (which may also be referred to as “itinerary elements”), such as any of the elements below. The term “itinerary” may also be rephrased as a “travel plan”.
Departure point and scheduled departure time
Destination and scheduled arrival time
Transportation and time required
Name and address of accommodation facility
Name and address of sightseeing spot
Order of visiting sightseeing spots and length of stay
Eating place and meal content
Budget and payment method

The following describes an example in which, for example, an itinerary is generated based on an interaction with a chatbot account in a messaging service. Note that, without limitation to a messaging service, the itinerary generation may also be implemented in a conversational AI system, such as ChatGPT.

In the following, a question answering system (which may also be referred to as a “question answering model”) may be used as an example of a method of realizing processing. The question answering system may be, for example, a closed-book question answering system implemented by a language model such as HyperCLOVA, GPT-4, or Llama. Also, the question answering model may be, for example, an open-book question answering system implemented by a combination of a language model and an external knowledge retrieval model such as a dense passage retriever (DPR) or a binary passage retriever (BPR). The question answering system may be configured to generate an output sentence (response sentence) in cooperation with any external database.

At least some example embodiments relate to enabling a reservation of a service based on an itinerary when the itinerary is generated through a conversation between a user of a terminal 20 and a chatbot on a chat application.

The content described in an example embodiment can also be applied in the same manner to any of the variations and the other examples, which will be described later.

In the following example embodiment, for example, a service for itinerary generation assistance is referred to as a “travel plan creation assistance service”. The travel plan creation assistance service may become available as a result of the user interacting with a chatbot in a messaging application, for example.

Note that, for example, any of the following modes can be applied as a mode for realizing the travel plan creation assistance service:
(A1) a mode in which a messaging application has the function of the travel plan creation assistance service as one of its functions;
(A2) a mode in which a travel plan creation assistance application that provides the travel plan creation assistance service has the function of the messaging service as one of its functions;
(B1) a mode of configuring an application (integrated application) that has the functions of the messaging service and the travel plan creation assistance service;
(C1) a mode of configuring a travel plan creation assistance application as an application separate from a messaging application;
(C2) a mode of configuring a messaging application as an application separate from a travel plan creation assistance application; and
(D) a mode of configuring a travel plan creation assistance application as a standalone application.

In the modes (A1), (A2), and (B1), for example, the messaging service provider can be the same as the travel plan creation assistance service provider.

In this case, a configuration is possible, as one method, in which the user uses the same user account across the messaging application and the travel plan creation assistance application.

Also, in this case, a configuration is possible, as another method, in which a user account on the messaging application is automatically associated (linked) with a user account on the travel plan creation assistance application.

In the modes (C1) and (C2), for example, the messaging service provider may be different from the travel plan creation assistance service provider.

Also, in the modes (C1) and (C2), it is possible to perform processing for associating (linking) a user account on the messaging application with a user account on the travel plan creation assistance application.

In the following description, for example, the messaging service provider manages and administers a server 10 for providing the messaging service and the travel plan creation assistance service, in accordance with the mode (A1).

In the following description, a user of a terminal 20 that communicates with the server 10 is referred to as a “user A.A”, a user of a terminal 20B as a “user B.B”, a user of a terminal 20C as a “user C.C”, and so on.

As used herein, expressions such as “at least one of,” when preceding a list of elements, modify the entire list of elements and do not modify the individual elements of the list. Thus, for example, both “at least one of A, B, or C” and “at least one of A, B, and C” mean either A, B, C or any combination thereof. Likewise, A and/or B means A, B, or A and B.

While the term “same,” “equal” or “identical” is used in description of example embodiments, it should be understood that some imprecisions may exist. Thus, when one element is referred to as being the same as another element, it should be understood that an element or a value is the same as another element within a desired manufacturing or operational tolerance range (e.g., ±10%).

When the term “about,” “substantially” or “approximately” is used in this specification in connection with a numerical value, it is intended that the associated numerical value includes a manufacturing or operational tolerance (e.g., ±10%) around the stated numerical value. Moreover, when the word “about,” “substantially” or “approximately” is used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

### System Configuration

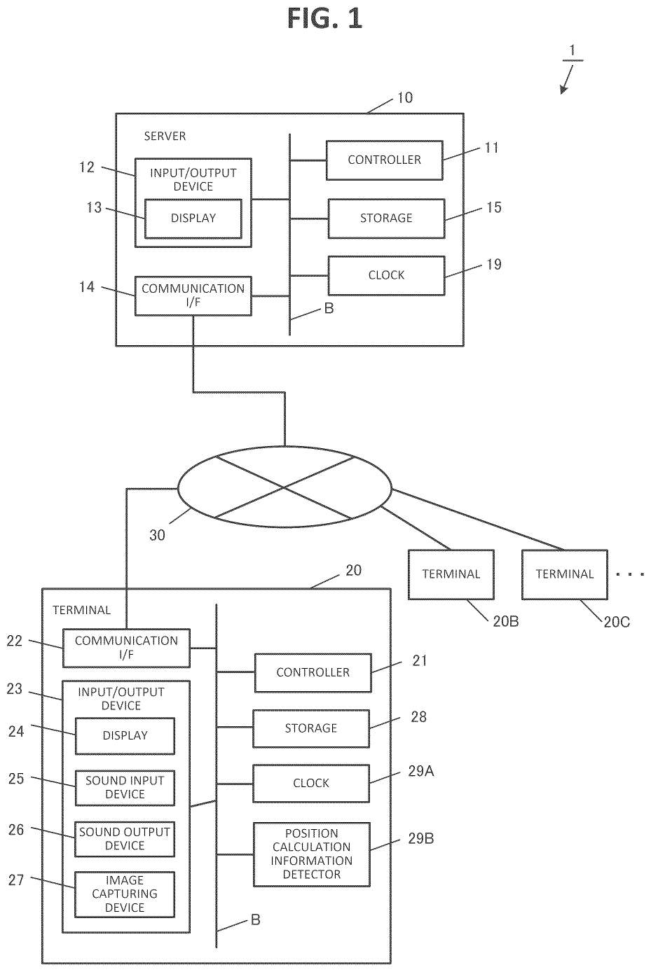

FIG. 1 shows an example of a system configuration of a communication system 1 according to an example embodiment. In the communication system 1, for example, the server 10 and a plurality of terminals 20 (terminals 20, 20B, 20C, . . . ) are connected to each other via a network 30.

The server 10 functions to provide, for example, a messaging service and a travel plan creation assistance service to the terminals 20 owned by the users, via the network 30.

The server 10 can also be referred to as, for example, a messaging service server, a travel plan creation assistance server, and a social media platform server. In an example embodiment, for example, the user of the server 10 is a company that provides the messaging service and the travel plan creation assistance service (a provider of the messaging service and the travel plan creation assistance service). Note that the number of servers 10 and terminals 20 that are connected to the network 30 is not limited to the above.

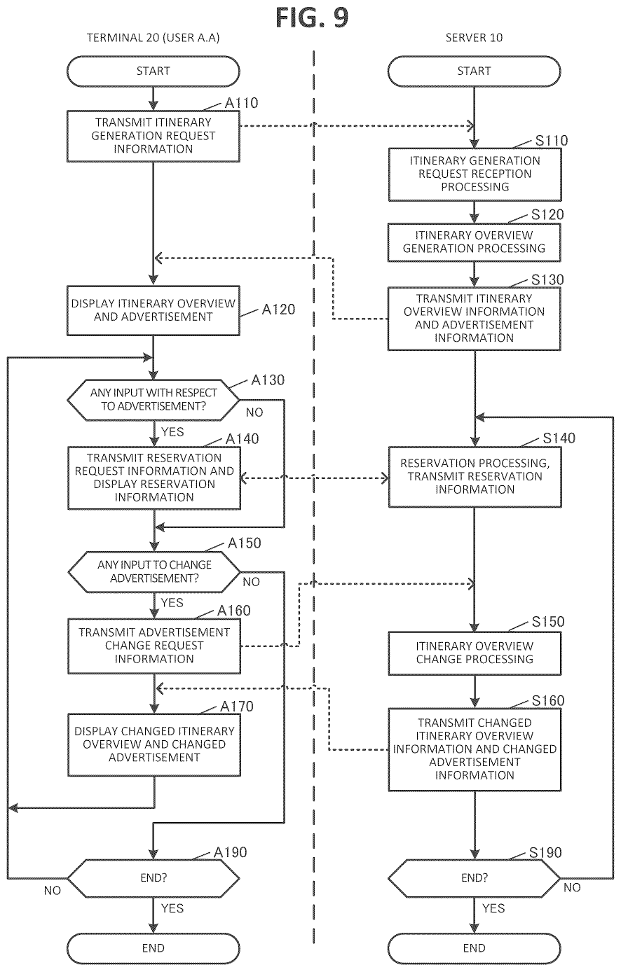

Note that, although it is stated in the above description that “the user of server 10 is a company that provides . . . ”, this company is not limited to a company that physically owns the server, but may also include a company that gives instructions to plan and execute control of the devices (or some of the devices) in the server 10, including a later-described controller 11, by using a server that is not owned by the company (e.g., a cloud server owned and operated by another company). Further, processing performed by any server is not limited to processing performed by a server controlled by one company. In other words, processing may also include a case where a plurality of companies control one or more servers (by distributing a plurality of processing operations, which will be described later, to the server(s)). As an example, later-described itinerary overview generation processing (e.g., S120 in FIG. 9, which will be described later) may be performed by a server controlled by (i.e., in accordance with planning and execution instructions from) a company A, and later-described reservation processing (S140 in FIG. 9, which will be described later) may be performed by another server that is controlled by (i.e., in accordance with planning and execution instructions from) a company B and is different from the server of company A, without being limited thereto. Similarly, processing may be implemented by processing performed by a plurality of servers controlled by one company. As an example, later-described itinerary overview generation processing (e.g., S120 in FIG. 9, which will be described later) may be performed by a server that is controlled by (i.e., in accordance with planning and execution instructions from) a company A, and later-described reservation processing (e.g., S140 in FIG. 9, which will be described later) may be performed by a server, which is controlled by (i.e., in accordance with planning and execution instructions from) the company A and physically different from the server, without being limited thereto.

In an example embodiment, the “travel plan creation assistance service” is a service provided by the provider (server 10) that is a company or the like providing the travel plan creation assistance service, and may be provided to, for example, the users (the terminals 20 of the users).

Each of the terminals 20 (terminals 20, 20B, 20C, . . . ) may be any type of information processing terminal that is capable of realizing the functions described in each example embodiment. Examples of the terminals 20 include a smartphone, a mobile phone (a feature phone), a computer (e.g., a desktop, a laptop, or a tablet), a media computer platform (e.g., a cable, a satellite set-top box, or a digital video recorder), a handheld computer device (e.g., a personal digital assistant (PDA) or an electronic mail client), a wearable terminal (an eyeglasses-type device, a watch-type device, etc.), a virtual reality (VR) terminal, a smart speaker (an audio recognition device), and any other type of computer or communication platform. The terminals 20 may also be referred to as “information processing terminals”.

The terminals 20, 20B, and 20C may have, for example, the same configuration. A terminal used by a user X may optionally be referred to as a “terminal 20X”, and user information associated with the user X or the terminal 20X in a desired (or, alternatively, a predetermined) service may optionally be referred to as “user information X”, as necessary.

The user information is information on a user associated with an account used by the user in the desired (or, alternatively, the predetermined) service. User information includes, for example, information that is input by the user or is assigned by the desired (or, alternatively, the predetermined) service, and that is associated with the user, such as the name, icon image, age, sex, address, hobbies and preferences, and identifier of the user. User information may optionally be any one of these types of information or a combination of two or more of these types of information.

The network 30 serves to connect the devices constituting the communication system 1. That is, the network 30 means a communication network that provides a connection path to enable various types of devices mentioned above to transmit and receive data after the devices are connected to each other.

One or more portions of the network 30 may optionally be a wired network or a wireless network. Examples of the network 30 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of a public switched telephone network (PSTN), a mobile phone network, an integrated service digital network (ISDN), a radio LAN, long term evolution (LTE), code division multiple access (CDMA), Bluetooth (registered trademark), satellite communication, and a combination of two or more of these networks. The network 30 may include one or more networks 30.

The server 10 (a non-limiting example of a server, an information processing device, or an information management device) functions to provide a desired (or, alternatively, a predetermined) service (a messaging service and travel plan creation assistance service in an example embodiment) to the terminals 20 and the like. The server 10 may be any information processing device that is capable of realizing the functions described in the example embodiments. Examples of the server 10 include a server device, a computer (e.g., a desktop, a laptop, or a tablet), a media computer platform (e.g., a cable, a satellite set-top box, or a digital video recorder), a handheld computer device (e.g., a PDA or an electronic mail client), and any other type of computer or communication platform. The server 10 may also be referred to as an “information processing device”. If the server 10 and the terminals 20 need not be distinguished from each other, each of the server 10 and the terminals 20 may optionally be referred to as an “information processing device”.

### Hardware (HW) Configurations of Devices

HW configurations of the devices included in the communication system 1 will be described.

### (1) HW Configuration of Terminal

FIG. 1 shows an example of a HW configuration of the terminal 20.

The terminal 20 includes, for example, a controller 21 (central processing unit: CPU), a storage 28, a communication I/F (interface) 22, an input/output device 23, a clock 29A, and/or a position calculation information detector 29B. The HW constituent elements of the terminal 20 are connected to each other via a bus B, for example. Note that it is not essential to include all of the constituent elements as the HW configuration of the terminal 20. For example, the terminal 20 may optionally be configured such that each one or a plurality of constituent elements are removable.

The communication I/F 22 transmits and receives various data via the network 30. Communication may be performed in a wired or wireless manner, and may be based on any communication protocol that enables mutual communication to be performed. The communication I/F 22 functions to communicate with various devices such as the server 10, via the network 30. The communication I/F 22 transmits various data to various devices, such as the server 10, in accordance with instructions from the controller 21. Also, the communication I/F 22 receives various data transmitted from various devices, such as the server 10, and transfers the data to the controller 21. The communication I/F 22 may also be simply referred to as a “communication device”. The communication I/F 22 may also be referred to as a “communication circuit” in the case where the communication I/F is constituted by a physically structured circuit.

The input/output device 23 includes, for example, a device that inputs various operations made to the terminal 20, and a device that outputs the results of processing performed by the terminal 20. The input/output device 23 may optionally be constituted by a single, integrated input and output device, or separate input and output devices.

The input device is implemented by any one of all types of devices capable of receiving input from a user and transferring information regarding the input to the controller 21, or a combination of two or more of these types of devices. Examples of the input device include a touch panel, a touch display, hardware keys of a keyboard or the like, a pointing device such as a mouse, a camera (operation input via moving images), and a microphone (operation input using voice).

The output device is implemented by any one of all types of devices capable of outputting the result of processing performed by the controller 21, or a combination of two or more of these types of devices. Examples of the output device include a touch panel, a touch display, a speaker (sound output), a lens (e.g., three-dimensional (3D) output or hologram output), and a printer.

As an example, the input/output device 23 includes, for example, a display 24, a sound input device 25, a sound output device 26, and/or an image capturing device 27.

The display 24 is implemented by any one of all types of devices capable of providing display in accordance with display data written in a frame buffer, or a combination of two or more of these types of devices. Examples of the display 24 include a touch panel, a touch display, a monitor (e.g., a liquid crystal display and an organic electroluminescence display (OELD)), a head mounted display (HDM), and devices capable of displaying images, text information, and the like using projection mapping or holograms, or in the air (may optionally be a vacuum). Note that the display 24 may optionally be capable of displaying display data three-dimensionally.

The sound input device 25 is used to input sound data (which may include audio data; the same applies hereinafter). The sound input device 25 includes a microphone or the like.

The sound output device 26 is used to output sound data. The sound output device 26 includes a speaker or the like.

The image capturing device 27 is used to acquire image data (which may include still image data and moving image data; the same applies hereinafter). The image capturing device 27 includes a camera or the like.

When the input/output device 23 is a touch panel, the input/output device 23 and the display 24 may have substantially the same size and shape and be arranged facing each other.

The clock 29A is a built-in clock of the terminal 20 and outputs time information (time measurement information). The clock 29A includes, for example, a clock that utilizes a crystal oscillator or the like. The clock 29A may also be referred to as, for example, a “time measurement device” or a “time information detector”.

Note that the clock 29A may optionally include a clock to which NITZ (Network Identity and Time Zone) standards or the like are applied.

The position calculation information detector 29B is a functional part that detects (measures) information (hereinafter referred to as “position calculation information”) that is necessary for the controller 21 to calculate (measure) the position of the terminal 20. The position calculation information detector 29B may also be referred to as a “position calculation sensor device”, for example.

Examples of the position calculation information detector 29B include a satellite positioning sensor (a satellite positioning unit) that is a sensor or a unit for calculating the position of the terminal 20 using a satellite positioning system, such as a global positioning system (GPS), an inertial measurement sensor (inertial measurement unit (IMU)) that is a sensor or a unit for calculating the position of the terminal 20 using an inertial navigation system, and a ultra-wide band (UWB) positioning sensor (UWB positioning unit) that is a sensor or a unit for calculating the position of the terminal 20 using a UWB.

The satellite positioning unit has, for example, an radio frequency (RF) receiving circuit that converts, into digital signals, RF signals, which include positioning satellite signals emitted from a positioning satellite and received by an antenna (not shown), and a baseband processing circuit that captures the positioning satellite signals by performing correlation operation processing or the like on the digital signals output from the RF receiving circuit and outputs, as position calculation information, information such as satellite orbit data and time data that are retrieved from the positioning satellite signals.

The inertial measurement unit includes an inertial sensor that detects information necessary to calculate the position of the terminal 20 through an inertial navigation operation. The inertial sensor includes, for example, a three-axis acceleration sensor and a three-axis gyroscope sensor, and outputs, as position calculation information, an acceleration detected by the acceleration sensor and an angular velocity detected by the gyroscope sensor.

The UWB positioning unit has, for example, a ultra-wide band radio frequency (RF) receiving circuit that converts, into digital signals, ultra-wide band RF signals including a positioning ultra-wide band pulse signal emitted from a positioning beacon and received by an antenna (not shown), and a relative position calculation processing circuit that calculates the relative positions of the terminal 20 and the positioning beacon based on the digital signals output from the ultra-wide band RF receiving circuit.

Note that, for example, the UWB positioning unit may optionally cause the terminal 20 to function as a positioning beacon by transmitting ultra-wide band RF signals including a positioning ultra-wide band pulse signal from the antenna (not shown).

For example, the controller 21 calculates the position of the terminal 20 at periodical or specified times, based on the position calculation information detected by the position calculation information detector 29B. The position of the terminal will be referred to as a “terminal position”, and the calculated terminal position will be referred to as a “calculated terminal position”. The controller 21 may optionally store, in the storage 28, the calculated terminal position as calculated terminal position history data in association with the date and time at which the calculated terminal position was calculated.

The controller 21 has a physically structured circuit for executing functions that are implemented by code or commands included in a program, and is implemented by, for example, a data processing device incorporated in hardware. Thus, the controller 21 may optionally be referred to as a “control circuit”.

Examples of the controller 21 include a central processing unit (CPU), a microprocessor, a processor core, a multiprocessor, an application-specific integrated circuit (ASIC), and a field programmable gate array (FPGA).

The storage 28 functions to store various programs and data that are necessary for the terminal 20 to operate. Examples of the storage 28 include various storage media, such as a hard disk drive (HDD), a solid state drive (SSD), a flash memory, a random access memory (RAM), and a read only memory (ROM). The storage 28 may optionally be referred to as a “memory”.

The terminal 20 stores a program P in the storage 28, and the controller 21 executes the program P to perform processing to serve as parts that are included in the controller 21. That is, the program P stored in the storage 28 causes the terminal 20 to implement the functions executed by the controller 21. The program P may optionally be referred to as a “program module”.

### (2) HW Configuration of Server

FIG. 1 shows an example of a HW configuration of the server 10.

The server 10 includes, for example, a controller (CPU) 11, a storage 15, a communication I/F (interface) 14, an input/output device 12, a display 13, and/or a clock 19. The HW constituent elements of the server 10 are connected to each other via a bus B, for example. Note that it is not essential to include all of the constituent elements as the HW configuration of the server 10. For example, the HW of the server 10 may optionally be configured such that each one or a plurality of constituent elements are removable.

The controller 11 has a physically structured circuit for executing functions that are implemented by code or commands included in a program, and is implemented by, for example, a data processing device incorporated in hardware.

The controller 11 is typically a central processing unit (CPU), and may optionally be a microprocessor, a processor core, a multiprocessor, an ASIC, or an FPGA. In the present disclosure, the controller 11 is not limited to these examples.

The storage 15 functions to store various programs and data that are necessary for the server 10 to operate. The storage 15 is implemented by various storage media, such as an HDD, an SSD, and a flash memory. However, in the present disclosure, the storage 15 is not limited to these examples. The storage 15 may optionally be referred to as a “memory”.

The communication I/F 14 transmits and receives various data via the network 30. Communication may be performed in a wired or wireless manner, and may be based on any communication protocol that enables mutual communication to be performed. The communication I/F 14 functions to communicate with various devices, such as the terminal 20, via the network 30. The communication I/F 14 transmits various data to various devices, such as the terminal 20, in accordance with instructions from the controller 11. Also, the communication I/F 14 receives various data transmitted from the various devices, such as the terminal 20, and transfers the data to the controller 11. The communication I/F 14 may also be referred to simply as a “communication device”. The communication I/F 14 may also be referred to as a “communication circuit” in the case where the communication I/F is constituted by a physically structured circuit.

The input/output device 12 includes, for example, a device that inputs various operations to the server 10, and a device that outputs the results of processing performed by the server 10. The input/output device 12 may optionally be constituted by a single, integrated input and output device, or separate input and output devices.

The input device is implemented by any one of all types of devices capable of receiving input from a user and transferring information regarding the input to the controller 11, or a combination of two or more of these types of devices. The input device is implemented by hardware keys, a typical example of which is a keyboard, and a pointing device such as a mouse. Note that, for example, the input device may optionally include a touch panel, a camera (operation input made via moving images), or a microphone (operation input using voice).

The output device is implemented by any one of all types of devices capable of outputting the result of processing performed by the controller 11, or a combination of two or more of these types of devices. Examples of the output device include a touch panel, a touch display, a speaker (sound output), a lens (e.g., 3D (three-dimensional) output and hologram output), and a printer.

As one example, the input/output device 12 includes, for example, a display 13.

The display 13 is implemented by a display or the like. The display is typically implemented by a monitor (e.g., a liquid crystal display or an organic electroluminescence display (OELD)). Note that the display may optionally be a head mounted display (HDM) or the like. Note that the display may optionally be capable of displaying display data three-dimensionally. In the present disclosure, the display is not limited to these examples.

The clock 19 is a built-in clock of the server 10 and outputs time information (time measurement information). The clock 19 includes, for example, a real time clock (RTC) as a hardware clock, a system clock, or the like. The clock 19 may also be referred to as, for example, a “time measurement device” or a “time information detector”.

### (3) Others

The server 10 stores the program P in the storage 15, and the controller 11 executes the program P to perform processing to serve as parts that are included in the controller 11. That is, the program P stored in the storage 15 causes the server 10 to implement the functions executed by the controller 11. The program P may optionally be referred to as a “program module”.

The same applies to the other devices.

Example embodiments of the present disclosure will be described as being implemented as a result of a CPU of the terminal 20 and/or the server 10 executing the program P.

The same applies to the other devices.

Note that the controller 21 of the terminal 20 and/or the controller 11 of the server 10 may optionally implement processing by using not only a CPU including a control circuit, but also a logic circuit (hardware) or a dedicated circuit formed on an integrated circuit (IC) chip or a large scale integration (LSI) chip. Further, these circuits may optionally be implemented by one or more integrated circuits, and a plurality of types of processing described in the example embodiments may optionally be implemented by a single integrated circuit. An LSI may also be referred to as a VLSI, a super LSI, an ultra LSI, or the like depending on the chip integration density. Accordingly, the controller 21 may optionally be referred to as a “control circuit”.

The same applies to the other devices.

The program P (e.g., a software program, a computer program, or a program module) in the example embodiments of the present disclosure may optionally be provided in a state of being stored in a computer-readable storage medium. The program P can be stored in a “non-transitory tangible medium”. Also, the program P may optionally be for implementing some of the functions described in the example embodiments of the present disclosure. Furthermore, the program P may optionally be a differential file (differential program) that enables the functions described in the example embodiments of the present disclosure to be implemented in combination with the program P that is already recorded in a storage medium.

The storage medium may include one or more semiconductor-based or other integrated circuits (ICs; e.g., field programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM drives, secure digital cards or drives, any other suitable storage media, or a suitable combination of two or more of these storage media. Where appropriate, the storage medium may consist only of a volatile storage medium or a non-volatile storage medium, or a combination of volatile and non-volatile storage media. Note that the storage medium is not limited to these examples, and may be any device or medium that is capable of storing the program P. Further, the storage medium may optionally be referred to as a “memory”.

The server 10 and/or the terminal 20 can implement functions of a plurality of functional parts described in the example embodiments by reading the program P stored in the storage medium and executing the read program P.

The same applies to the other devices.

The program P according to example embodiments of the present disclosure may optionally be provided to the server 10 and/or the terminals 20 via any transmission medium (a communication network, broadcast waves, etc.) that is capable of transmitting the program. The server 10 and/or the terminals 20 implement(s), for example, the functions of the functional parts described in the example embodiments by executing the program P downloaded via the Internet or the like.

The same applies to the other devices.

The example embodiments of the present disclosure may also be implemented in the form of a data signal in which the program P is embodied by electronic transmission.

At least a portion of processing performed in the server 10 and/or the terminal 20 may optionally be implemented through cloud computing constituted by one or more computers.

At least a portion or all of processing to be performed in the terminals 20 may optionally be performed by the server 10. In this case, the server 10 may optionally perform processing to be performed by some or all of the functional parts of the controller 21 of the terminal 20.

At least a portion or all of processing to be performed in the server 10 may optionally be performed by the terminals 20. In this case, the terminal 20 may optionally perform processing to be performed by some or all of the functional parts of the controller 11 of the server 10.

In the example embodiments of the present disclosure, configurations for determination are not essential unless explicitly mentioned otherwise. Desired (or, alternatively, predetermined) processing may optionally be activated when a determination condition is satisfied or when a determination condition is not satisfied.

The program according to example embodiments of the present disclosure is implemented using, for example, a script language such as ActionScript or JavaScript (registered trademark), a compiler language such as Objective-C or Java (registered trademark), or a markup language such as HTML Living Standard.

### Functional Configuration of Each Device

### (1) Functional Configuration of Server

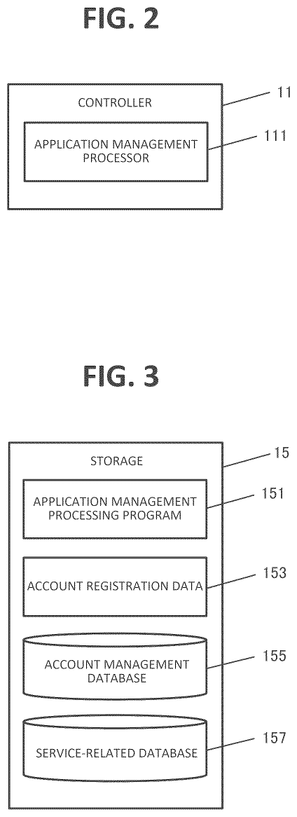

FIG. 2 shows an example of a function implemented by the controller 11 of the server 10 in an example embodiment.

The controller 11 includes, for example, an application management processor 111 as a functional part.

The application management processor 111 functions, for example, to perform application management processing in accordance with an application management processing program 151 stored in the storage 15.

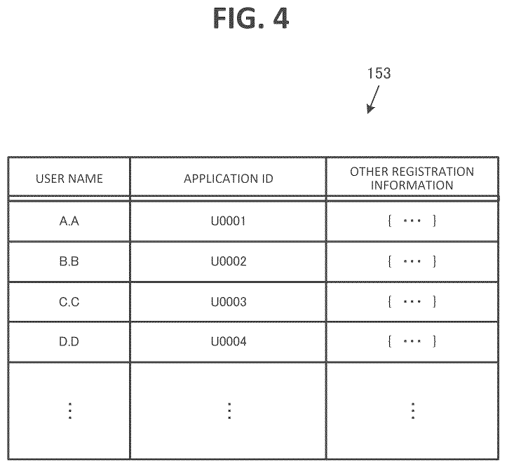

FIG. 3 show an example of information stored in the storage 15 of the server 10 in an example embodiment, and FIG. 4 shows an example of account registration data according to the example embodiment.

Referring to FIGS. 3 and 4, the storage 15 stores, for example, the application management processing program 151 that is executed as application management processing, an account registration data 153, an account management database 155, and/or a service-related database 157.

The account registration data 153 is registration data related to accounts on a messaging service, and an example of a data configuration thereof is shown in FIG. 4.

The username refers to a name of an account of the terminal 20 that uses the messaging application. For example, a name registered by the user of the terminal 20 when using the messaging application is stored as the username.

The application ID is information that is used to identify an account of the messaging service, or the account itself.

The application ID is preferably a value unique to each account. For example, a value (specific value) unique to each account is set and stored as the application ID by the server 10.

The application ID is information associated with the terminal 20 or the user of the terminal 20, and is an example of information regarding the terminal or information regarding the user of the terminal.

Other registration information may include, for example, various types of information such as identification information for identifying the terminal 20, a telephone number (terminal telephone number) of the terminal 20, an email address (terminal email address), and authentication information such as a password (login password, authentication password etc.) used in various authentications on the application.

Identification information for identifying the terminal 20 may be, for example, a terminal ID (e.g., an IMEI (International Mobile Equipment Identity)).

For example, other registration information may be stored in association with user information.

Note that the term “application ID” may alternatively be, but need not necessarily be, referred to as the term “user ID”. If the application allows registration of only one account per terminal 20, for example, identification information for identifying the terminal 20 may be equivalent to identification information for identifying the user of the terminal 20, and may also be equivalent to the application ID.

For example, a plurality of terminal IDs may optionally be allocated to one application ID. In this case, the application may optionally be started on a plurality of terminals 20 at the same time for one application ID as an identification (login) target.

Instead of using various IDs such as the application ID, a technique of managing each account using information such as a terminal telephone number can also be applied.

In this case, instead of storing ID information such as the application ID as the account registration data 153, information such as the terminal telephone number can be stored as the account registration data 153. Note that, instead of replacing the ID information such as the application ID with the information such as the terminal telephone number, the ID information such as the application ID may optionally be stored in one-to-one correspondence with the information such as the terminal telephone number.

In the description of the following example embodiment, it is assumed that one account is registered per terminal 20 for simplicity of explanation.

In this case, since the identification information for identifying the terminal 20 is equivalent to the identification information for identifying the user of the terminal 20 and to the application ID as mentioned above, the term “a user of an account” used in the following description may optionally be considered to be substantially synonymous with “a terminal of an account”.

The account management database 155 is, for example, a database that stores account management data as management data for each user account on the messaging service that is stored as the account registration data 153.

For example, friend relationships of a user of each account on the messaging service, information regarding the transmission and reception of messages, and the like may be stored as account management data.

The service-related database 157 is a database that stores, for example, information regarding advertisements related to various services (e.g., advertisement identification information, information such as advertisement images), information regarding reservation services that use the advertisements and providers of reservation services (hereinafter referred to as “reservation service providers”) (e.g., reservation service identification information, information such as URLs of reservation service websites and web pages).

Note that the database may be divided into two or more databases. For example, an advertisement database may be separately configured.

Further, the service-related database 157 may be managed by a storage in a server different from the server 10, and processing may be performed by the server 10 and the other server interacting with each other.

The various services may include, for example, food and beverage services at eating establishments and accommodation services at accommodation facilities, and these services will be referred to as “facility use services” for convenience, and providers of those services will be referred to as “facility use service providers”, for convenience.

The reservation service providers may be business operators that partner with the aforementioned facility use service providers, and place advertisements related to the facility use services and accept reservations for the facility use services, in accordance with requests from the aforementioned facility use service providers. For example, the reservation services may include a “gourmet reservation service”, an “accommodation reservation service”, and the like.

Note that the various services are not limited to facility use services, and may include, for example, transportation use services that involve public transportation. Also, the reservation services may include a service with which reservations for the transportation use services can be made.

For example, the above various services can be included in an itinerary, and may be retrieved as services related to the itinerary.

The advertisements are those associated with the above services, and may be, for example, advertisements from facility use service providers or advertising agencies as advertisers.

Regarding the advertisements, even for the same facility use service, the same advertisement is used regardless of the reservation service (reservation service provider) in some cases, and different advertisements may be used by respective reservation services in other cases. In the description of an example embodiment, the same advertisement is used regardless of the reservation service. That is to say, in the following description, one advertisement is associated with a plurality of reservation services (reservation service providers).

In the following description, a business operator that serves as a sponsor of the messaging service provider is referred to as a “sponsor”.

Sponsors may include at least either one of a facility use service provider and a reservation service provider. For example, sponsors may include a reservation service provider that is an investor of the messaging service provider, a facility use service provider that is an advertiser and has paid advertising fees in advance, or the like. A sponsor advertisement (mainly an advertisement from a facility use service provider that pays advertising fees in advance) is referred to as a “sponsored advertisement”.

In the description of an example embodiment, for each user (for each account) registered as the account registration data 153, information about an account of a reservation service owned by the user (this account) is stored as the account registration data 153 (or account management data). Also, in the following description, information indicating whether a user's account on the messaging service and a user's account on a reservation service are linked (information indicating whether the accounts are linked) is stored. The linkage between the user's account on the messaging service and the user's account on a reservation service is referred to as “account linkage”, and processing for the linkage is referred to as “account linkage processing”.

Note that past reservation information and actual use history information for each reservation service may be stored for each user (for each account) registered as the account registration data 153.

It is also possible that a user (the account of this user) does not own an account with the reservation service, but this case will be excluded for simplicity in an example embodiment.

### (2) Functional Configuration of Terminal

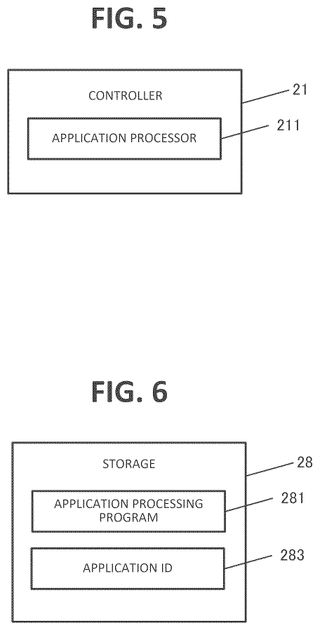

FIG. 5 shows an example of functions implemented by the controller 21 of the terminal 20 in this example.

For example, the controller 21 includes, as a functional part, an application processor 211 for performing application processing in accordance with an application processing program 281 stored in the storage 28.

FIG. 6 shows an example of data or the like stored in the storage 28 of the terminal 20 in an example embodiment.

The storage 28 stores, for example, the application processing program 281 that is executed as application processing, and an application ID 283 that corresponds to the terminal 20 or the account of the user of the terminal 20.

### Display Screen

The following describes examples of display screens. Transitions of display screens described below are merely examples of transitions of display screens for realizing the method of the present disclosure. Regarding the following examples of transitions of display screens, the display of some display screens may be omitted, or another display screen may be added.

Also, the terms used in the display screens described below and the terms used in the processing described later may be different (some terms may not be unified).

The following describes an example in which the terminal 20 is a smartphone having the display 24 that is a vertical display. For example, the smartphone has a touch panel, which functions as an input device and is arranged facing the display to constitute a touchscreen. When an element such as an icon, a button, an item, or an input field is displayed in the display, and the user performs an operation on an area of the touch panel facing the area where the element is displayed, a program associated with the element or a subroutine of the program may be executed.

Note that, in some cases, the flow of a screen transition is illustrated by showing desired (or, alternatively, predetermined) screens displayed on different terminals 20 within one drawing or across two or more drawings. In such cases, for example, the different terminals 20 may be configured to display a desired (or, alternatively, a predetermined) screen based on at least one of the following events (i.e., in response to at least one of the following events as a trigger):
the desired (or, alternatively, the predetermined) screen is automatically displayed;
a certain notification (including a push notification, etc.; the same applies to the following) is given to the terminal 20, and the desired (or, alternatively, the predetermined) screen is displayed in response to the user performing an operation on the notification;
no notification is given to the terminal 20, and the desired (or, alternatively, the predetermined) screen is displayed in response to the user performing a desired (or, alternatively, a predetermined) operation on the application; or
a certain notification is given to the terminal 20, and the desired (or, alternatively, the predetermined) screen is displayed in response to the user performing a desired (or, alternatively, a predetermined) operation on the application to which the notification has been given.

The following illustrates a case where an account of the terminal 20 of the user A.A is an example of an account that initiates generation of a travel plan. The terminal 20 may be an example of a first terminal, and the user A.A may be an example of a first user of a first terminal. An account of the terminal 20 or the user A.A may be an example of a first account.

In this example, a travel plan is generated within the messaging application, and “Messaging App” is represented as an example of the name of the messaging application.

Note that the generation of a travel plan may be enabled on an application different from the messaging application, e.g., a travel plan generation assistance application. In this case, for example, an itinerary may be presented on the travel plan generation assistance application based on an interaction in a talk room on the messaging application.

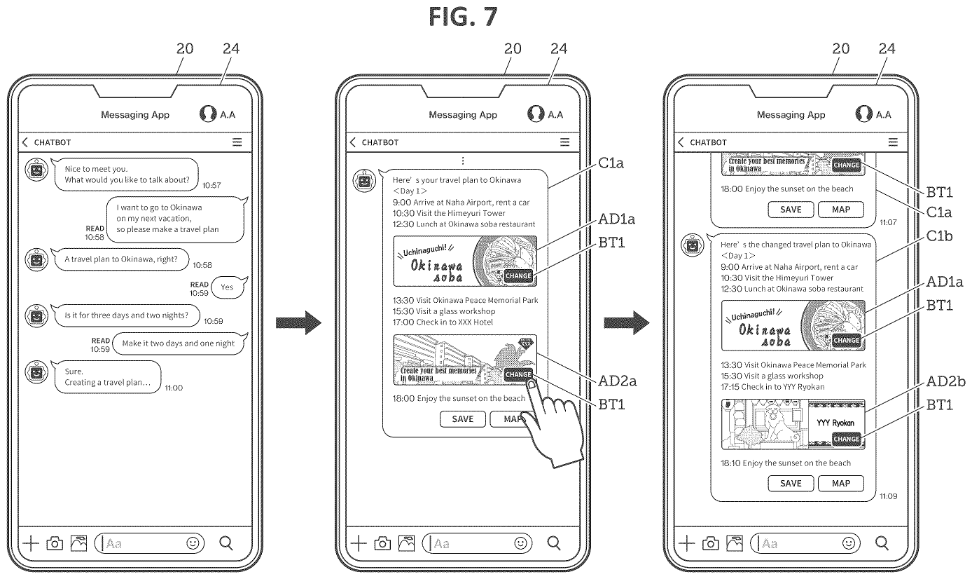

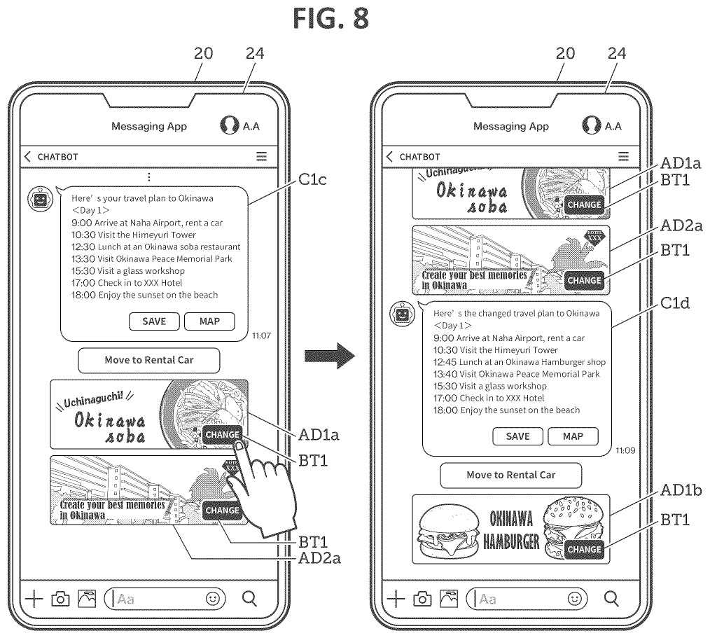

FIGS. 7 and 8 show examples of screens displayed on the display 24 of the terminal 20 in this example.

Referring to FIGS. 7 and 8, note that the term “travel plan”, as used in the drawings, is rephrased as an “itinerary” in the following description, as appropriate.

The left side of FIG. 7 shows a talk room screen on the messaging application displayed on the terminal 20 that is a talk room screen with a chatbot (chatbot account) as a conversation partner.

On the talk room screen, an area in which content and information similar thereto are displayed (hereinafter referred to as a “content display area”) CR is configured. For example, content transmitted by the user themself (i.e., content whose transmission source is the user) may be displayed on the right side of the screen, and content transmitted by the talk partner (i.e., content whose transmission source is the talk partner) may be displayed on the left side of the screen.

Note that the same may be implemented in a group talk room. In this case, for example, a configuration may be used in which the content transmitted by the user of the terminal (the content originating from the user of the terminal) is displayed on the right side of the screen, and the content transmitted by the group members other than the user of the terminal (which may include the chatbot (chatbot account)) (the content originating from the group members other than the user of the terminal) is displayed on the left side of the screen in a content display area CR.

For example, the content may be displayed in association with information that enables specification or identification of the transmission source, and may be, for example, displayed in association with the registered icon image of the user. Further, the content may be displayed in a balloon. In this case, the text or the like in the balloon may be regarded as content, or the balloon itself may also be regarded as being included in the content.

Also, the content may be displayed without a balloon, depending on the type of content and information included in the content.

Different elements (e.g., text, images, and objects such as buttons and icons) may be included in one content item. Such a content item may be referred to as “composite content”, for example.

On the left screen in FIG. 7, the user A.A and the chatbot are communicating regarding itinerary generation of a travel to Okinawa, and the last content item is displayed indicating that the chatbot is generating an itinerary.

The screen at the center in FIG. 7 is a continuation from the screen on the left side in FIG. 7, and displays an itinerary C1a generated by the chatbot as a content item originating from the chatbot.

An itinerary that is displayed as a chat in this manner may be regarded as a content item (itinerary content item), and may be configured as, for example, a composite content item.

An example embodiment illustrates a case where an itinerary (itinerary overview) that indicates an overview of a travel itinerary is generated and displayed. However, in addition, or alternatively, a detailed itinerary (itinerary details) that individually and specifically indicates a travel itinerary may be generated and displayed.

In this example, the itinerary C1a includes text representing the itinerary. Also, advertisements (advertisement images) of facility use services included in the itinerary are displayed. Specifically, in this example, an advertisement AD1a of “Okinawa soba restaurant”, which provides a food and beverage service, and an advertisement AD2a of “XXX hotel”, which provides an accommodation service, are included. The itinerary C1a also includes a “save” button for saving this itinerary and a “map” button for displaying the itinerary in the form of a map.

For example, a link for transitioning to an in-application reservation information input page, which will be described later, is set in the advertisement AD1a of “Okinawa soba restaurant”. When the user taps the advertisement AD1a, for example, an internal browser of the messaging application (in-application browser) causes the display 24 to display the in-application reservation information input page of the messaging application.

Here, AD1a (and AD2a, as well as AD2b etc., which will be described later) is expressed as “advertisement”, but is not limited to an advertisement for which an advertiser pays an advertising fee, and may alternatively be a search result obtained by extracting, for example, information about stores posted on the Internet through a search. Note that an advertisement may also be regarded as a search result. Only an advertisement may be displayed as described above, or only a search result that is not an advertisement may be displayed, or both an advertisement and a search result that is not an advertisement may be displayed in a mixed manner. Further, a search result that is not an advertisement may be, for example, a content item (an object) generated by the server 10 based on a search result.

Note that the above description may be of a case in which an account of the user A.A in a first gourmet reservation service and an account of the user A.A in the messaging service have already been linked (account linkage has already been performed).

Similarly, for example, a link for transitioning to an in-application reservation information input page is set in the advertisement AD2a of “XXX hotel”.

Further, for example, a “change” button BT1 for changing an advertisement to another advertisement is displayed at a lower right portion of each advertisement, in association with the advertisement. The “change” button BT1 may be regarded as an object for changing an advertisement. Since not only an advertisement but also an itinerary is changed in an example embodiment, the “change” button BT1 may be regarded as a type of object for changing an itinerary.

For example, when the user taps the “change” button BT1 associated with the advertisement AD2a of “XXX hotel”, the itinerary C1a and the advertisement AD2a of “XXX hotel” are changed.

Note that the same may apply to displaying a search result that is not an advertisement.

The screen on the right side in FIG. 7 is a screen displayed following the screen at the center in FIG. 7, and displays a changed itinerary C1b below the itinerary C1a.

In this itinerary C1b, the accommodation facility has been changed from “XXX Hotel” to “YYY Ryokan”. Based on this change, the check-in time (arrival time) at the accommodation facility and the subsequent scheduled times have been updated.

Also, an advertisement AD2b of “YYY ryokan” is displayed in place of the advertisement AD2a of “XXX hotel”. This advertisement AD2b is also set with a link for transitioning to an in-application reservation information input page, for example.

For example, when the user taps the advertisement AD2b of “YYY ryokan”, the in-application reservation information input page is displayed on the display 24, allowing the server 10 to reserve accommodation at “YYY ryokan”. The details will be described later.

FIG. 8 shows other examples of the above screens. These screens are example screens when an itinerary and advertisements are displayed separately.

Referring to FIG. 8, an example screen on the left side in FIG. 8 displays an itinerary C1c that corresponds to the aforementioned itinerary C1a and does not contain advertisements. Below the itinerary C1c, a text content item is displayed that contains text “Move to Rental Car”, which corresponds to “Rent a car” in the itinerary C1c. Below this text content item, advertisements related to the services included in the itinerary C1c are displayed separately, which are, in this example, the advertisement AD1a of “Okinawa soba restaurant” that provides a food and beverage service, and the advertisement AD2a of “XXX Hotel” that provides an accommodation service.

For example, when the user taps the “change” button BT1 associated with the advertisement AD1a of “Okinawa soba restaurant”, the itinerary C1c and the advertisement AD1a of “Okinawa soba restaurant” are changed.

The screen on the right side in FIG. 8 is a screen that is displayed in this case following the screen on the left side in FIG. 8. A changed itinerary C1d is displayed below the aforementioned advertisement AD2a of “XXX Hotel”, and an advertisement AD1b of “Okinawa hamburger shop”, which is an advertisement changed from the advertisement AD1a of “Okinawa soba restaurant”, is displayed below the text content item “Move to Rental Car”.

For example, when the user taps the advertisement AD1b of “Okinawa hamburger shop”, the in-application reservation information input page is displayed on the display 24, allowing the server 10 to make an eating and drinking reservation at “Okinawa hamburger shop”. The details will be described later.

Note that, in the above example, two advertisements are presented that are displayed to lead the user to the reservation of the services in accordance with the itinerary. However, example embodiments are not limited to this example.

For example, for all reservable services, services present within a certain distance from a travel route are retrieved as target services via a search system (not shown). Then, service information regarding some or all of the target services (e.g., objects related to the services, such as advertisements) may be presented. Regarding this presentation in this case, many pieces of service information may be contained in the itinerary display area. For this reason, the service information may be displayed outside the itinerary display area (as shown in FIG. 8).

Note that, as mentioned as “some or all”, service information may be presented regarding only some of the target services retrieved by the search system. That is to say, a configuration may be used in which service information about some of the plurality of target services retrieved by the search system is presented, while service information about the other of the target services is not presented.

Further, it is not necessary to display all pieces of the service information extracted by the search within the area of the display 24. For example, only some of the search results may be displayed (or only a portion of an advertisement image may be displayed), and hidden pieces of service information may be displayed in response to the user performing a left or right swipe operation (the display may be either inside or outside of the itinerary).

Furthermore, in a case of presenting some or all of the target services present within a certain distance from the travel route via the search system as described above, only a part of the service information may be a sponsor slot, and service information provided by an advertiser who has paid an advertising fee in advance may be displayed therein. In this case, the service information in this sponsor slot may be displayed at, for example, an uppermost part of the itinerary (or at a leftmost part of the itinerary when hidden pieces of service information are displayed by swiping to the right) even when no user operation is received. That is to say, the service information in the sponsor slot may be displayed preferentially over the service information not in the sponsor slot. Furthermore, the service information in the sponsor slot may be displayed in association with text, a mark, or the like indicating the sponsor slot such that the user can identify whether the displayed service information is in the sponsor slot.

### Processing

FIG. 9 is a flowchart showing an example flow of processing performed by each device in an example embodiment.

Referring to FIG. 8, in this figure, an example of processing performed by the controller 21 of the terminal 20 of the user A.A is shown in the left diagram of the flowchart, and an example of processing performed by the controller 11 of the server 10 is shown in the right diagram.

Note that the processing described below is merely an example of processing for implementing the method according to some example embodiments, and example embodiments are not limited to this processing.

Further, another step may be added to the following processing, or some steps may be omitted (deleted) from the following processing.

In Operation A110, for example, the controller 21 of the terminal 20 transmits itinerary generation request information for generating an itinerary to the server 10 based on input to the input/output device 23 of the terminal 20 (e.g., user input such as operation input or sound input by the user; the same may apply hereinafter).

Note that the itinerary generation request information may be, for example, a character string in a natural language, such as “create a travel plan”. Also, the itinerary generation request information may be, for example, a command of an API in the travel plan creation assistance service.

The itinerary generation request information may include, for example, general information regarding travel destinations (places), information regarding the length of stay (“two days and one night”, etc.), information regarding the dates (“next weekend”, “from December 23 to December 26” etc.), and information regarding a purpose of the travel.

A means for inputting the itinerary generation request information may be, for example, as follows:
message posting to a talk room in the messaging service;
an operation of an itinerary generation button or input to a selection menu (form) from a talk room menu in the messaging service;
text input (interactive instruction) in the travel plan creation assistance application; and
input to a selection menu (form) in the travel plan creation assistance application.

Upon receiving the itinerary generation request information from the terminal 20, in operation S110, the controller 11 of the server 10 performs itinerary generation request reception processing.

In the itinerary generation request reception processing, the controller 11 of the server 10 determines whether an instruction to create an itinerary has been given, using, for example, a question answering model (not shown).

For example, if, in the itinerary generation request reception processing, the itinerary creation request information does not include information regarding a travel destination, dates, or the like, the controller 11 of the server 10 may transmit itinerary check information to the terminal 20 to check the travel destination, dates, or the like. For example, upon receiving the itinerary check information, the controller 21 of the terminal 20 may cause the display 24 to display the received itinerary check information.

The controller 21 of the terminal 20 may also transmit itinerary designation information regarding a travel destination, dates, or the like to the server 10 based on a user input with respect to the itinerary check information.

If, for example, it is determined that an instruction to generate an itinerary has been given, in operation S120, the controller 11 of the server 10 performs itinerary overview generation processing.

In the itinerary overview generation processing, the controller 11 of the server 10 generates an itinerary overview (an example of an itinerary) based on the content of instructions in the itinerary generation request information and the itinerary designation information, by using, for example, a question answering model (e.g., a closed-book question answering system).

For example, if the controller 11 of the server 10 receives a character string “I want to go to Okinawa, so make a travel plan” as the itinerary generation request information, and a character string “Make it two days and one night” as the itinerary designation information, the controller 11 may separate the itinerary generation request information and the itinerary designation information with a punctuation mark, and input a first prompt sentence “I want to go to Okinawa, so make a travel plan. Make it two days and one night”. Note that the itinerary designation information need not necessarily be used.

Furthermore, in the itinerary overview generation processing, for example, if the controller 11 of the server 10 receives a selection menu item “Make a travel plan” as the itinerary generation request information, and selection menu items “Region: Okinawa” and “Travel duration: two days and one night” as the itinerary designation information, the controller 11 may make a first prompt sentence by separating, with punctuation marks, a character string “Please generate a travel plan”, which is a character string associated with the selection menu item “Make a travel plan”, as the itinerary generation request information, a character string “Please make Okinawa the destination,” which is a character string associated with the selection menu item “Region: Okinawa” and a character string “Please make the travel duration two days and one night,” which is a character string associated with the selection menu item “Travel duration: two days and one night”, as the itinerary designation information, and input the first prompt sentence into the question-answering model. Note that the itinerary designation information need not necessarily be used.

The itinerary may include, for example, the following elements:-a departure location (e.g., a station, an airport, etc. to be an arrival location in an outward trip);—a place to visit (e.g., the name, address, etc. of a facility);—an eating establishment (e.g., the name of a restaurant, meal content, etc.);—an accommodation (e.g., the name, address, etc. of a hotel); and—an arrival location (e.g., a station, an airport, etc. to be a departure location in a return trip)

The first prompt sentence may include content indicating that the output includes any of these elements. Further, the first prompt sentence may also incorporate a prompt sentence for requesting that a more detailed schedule and costs be output.

The itinerary overview information may be, for example, a generated sentence that describes rough content of a travel plan. Also, the itinerary overview information may be, for example, a list of a departure point, a place to visit, and an accommodation. The itinerary overview information may also include, for example, information regarding a rough schedule, estimated costs, or the like.

Also, in S120, the controller 11 of the server 10 obtains an advertisement for a facility use service based on the generated itinerary from, for example, the service-related database 157. Then, for example, the controller 11 of the server 10 associates the obtained advertisement with the generated itinerary. The advertisement includes, for example, a link for transitioning to a page within the messaging application for the user to input information required to have the server 10 make a reservation (hereinafter referred to as an “in-application reservation information input page”).

In operation S130, the controller 11 of the server 10 transmits information about the generated itinerary and information about the advertisement associated with the itinerary (which may include information such as advertisement identification information and an advertisement (advertisement image) including the link) to the terminal 20 via the communication I/F 14.

In operation A120, upon receiving the above information from the server 10 via the communication I/F 22, the controller 21 of the terminal 20 causes the display 24 to display the itinerary and the advertisement.

As mentioned above, in S120, target services present within a certain distance from the travel route may be retrieved by the search system, and an itinerary that includes service information (e.g., an object such as an advertisement) of some or all of those services may be generated. In this case, when generating an itinerary, for example, the server 10 may also generate a search prompt sentence for searching for the target services, search for the target services in the search system using the generated search prompt sentence, and then obtain the service information about the target services.

Further, in this case, the server 10 may also transmit, for example, carousel advertisements (advertisements displayed in a carousel format) of the target services to the terminal 20 so as to cause the display 24 of the terminal 20 to display the carousel advertisements outside the itinerary display area as shown in FIG. 8 (or within the itinerary display area as shown in FIG. 7). In this case, for example, the carousel advertisements are displayed in association with the itinerary in the talk room displayed on the display 24 of the terminal 20, and the user can select an advertisement for a service they want to use by performing a swipe operation.

For example, the server 10 may generate an itinerary so as to include only facility use services of sponsors, or may generate an itinerary so as to include only facility use services of sponsors that have paid an advertising fee of a certain amount or more, out of facility use services provided by sponsors.

In addition, for example, the server 10 may generate an itinerary so as to include only facility use services that have been evaluated by service users as being higher than or equal to a desired (or, alternatively, a predetermined) level.

In operation A130, the controller 21 of the terminal 20 determines whether a user input has been made with respect to an advertisement displayed on the display 24.

If it is determined that no user input has been made with respect to an advertisement (A130: NO), for example, the controller 21 of the terminal 20 advances the processing to A150.

On the other hand, if it is determined that a user input has been made with respect to an advertisement (A130: YES), in operation A140, the controller 21 of the terminal 20 causes the display 24 to display an in-application reservation information input page using, for example, an in-application browser, based on the link included in the advertisement. Further, the controller 21 of the terminal 20 transmits information for requesting the server 10 to make a reservation (hereinafter referred to as “reservation request information”) based on the information input by the user, via the communication I/F 22 to the server 10.

Upon receiving the reservation request information from the terminal 20 via the communication I/F 14, in operation S140, the controller 11 of the server 10 performs reservation processing. Specifically, for example, one reservation service is selected from reservation services to which the account of the user A.A is linked, based on either of the following conditions:
(A) a reservation service of a sponsor reservation service provider; or
(B) a reservation service with the highest number of past reservations and/or past uses by the user A.A (or with the highest frequency of reservation and/or use).

In this case, a reservation service for making a reservation is selected from the reservation services to which the account of the user is linked, and a reservation service to which the account of the user is not linked is not selected.

Note that the conditions (A) and (B) may be combined.

Further, the user may select one reservation service from the reservation services to which the account of the user is linked.

Then, the controller 11 of the server 10 communicates with a server of the selected reservation service (the selected reservation service provider) via the communication I/F 14 to reserve a corresponding service for the user A.A. The controller 11 of the server 10 then stores the reservation details in association with the account of the user A.A.

Although the server 10 performs the reservation processing here, a server different from the server 10 (e.g., a reservation processing server (not shown)) may alternatively perform the reservation processing.

On the other hand, when no reservation service is linked with the account of the user, the controller 11 of the server 10 selects one reservation service, such as:
a reservation service of one of the sponsor reservation service providers;
a reservation service that is most frequently used by users within the messaging service; or
a reservation service with the highest user ratings within the messaging service,
and transmits information about the selected reservation service to the terminal 20 to present the information to the user of the terminal 20. The controller 11 of the server 10 may then perform account linkage processing after obtaining the user's approval, and subsequently perform the same processing as described above. Alternatively, the screen may switch to a web page of the reservation service without the account linking process being performed, and the user may proceed with the reservation process separately. In this case, for example, a configuration may be used in which the user returns to the messaging application after completing the reservation, and inputs, for example, information indicating that the reservation has been completed for a desired (or, alternatively, a predetermined) service into a text box, thereby enabling the controller 11 or the storage 15 to process, or manage and store the finalization of the travel itinerary.

Note that the itinerary may also include a travel cost (e.g., transportation cost, food and beverage cost, accommodation costs).

Further, the travel cost may be reduced if the user selects an advertisement associated with the itinerary and makes a reservation through a reservation service. For example, if the user reserves a hotel, the accommodation cost at this hotel may be reduced. Further, in this regard, the travel cost may be reduced by making a reservation through a sponsored reservation service. In this case, for example, information such as “XXX Hotel is selected from the sponsor slots for this itinerary. Accordingly, a discount of XX % is applied.” may be transmitted from the server 10 to the terminal 20 and displayed on the display 24 of the terminal 20. In this case, for example, this information may be displayed as a content item in the talk room in which the itinerary is displayed.

When the reservation processing in S140 is performed, processing for checking user information and the like may be performed through a conversation in the messaging service. In this case, for example, the server 10 may cooperate with a reservation processing server to obtain items required to be checked with the user to make the reservation, and may present a message to the user in text format (or image format etc.) within the messaging service for the check.

With this, the reservation server performs reservation processing based on an account associated with the cooperating reservation service (application), while the reservation is completed without moving to another application, which saves time and effort of the user.

Further, when the reservation is completed only through chat interaction, the user cannot understand which reservation service is associated with the completed reservation processing. For this reason, for example, when making a reservation, confirmation text (a text chat) such as “This reservation will be made using XX reservation application linked to A.A's account. Would you like to continue?” may be transmitted and displayed. Further, when text such as “Yes” is transmitted from the user terminal that received the text chat, the server 10 may recognize the text and transmit a reservation execution instruction to the reservation processing server to execute the reservation processing.

Further, in S140 , when the reservation is completed through the reservation processing, the server 10 (or the reservation processing server) may transmit reservation information (which may also be referred to as reservation completion information) to the terminal 20. Specifically, for example, in addition to a message stating that the reservation has been completed, the server may transmit and display a message “The reservation has been completed. You can confirm the reservation on ∘∘ reservation application”, and a URL (a link based on this URL) for displaying a reservation completion page of the reservation service application (a reservation completion page of the service reserved in this reservation service). The reservation information may include the details of the reservation and the like.

These pieces of information may be displayed, for example, in the aforementioned talk room in which the itinerary is displayed (i.e., the talk room that includes the user of the terminal 20 and the chatbot).

However, without limitation thereto, the information may be displayed in a talk room different from the talk room in which the itinerary is displayed, or in another page of the messaging application.

In addition, the user may be enabled to publish the generated itinerary by posting (sharing) the generated itinerary within the messaging service or to another social medial platform.

Thereafter, in operation A150, the controller 21 of the terminal 20 determines whether a user input for changing an advertisement has been made.

If it is determined that no user input for changing an advertisement has been made (A150: NO), for example, the controller 21 of the terminal 20 advances the processing to A190.

On the other hand, if it is determined that a user input for changing an advertisement has been made (A150: YES), in operation A160, the controller 21 of the terminal 20 transmits advertisement change request information for requesting a change of the advertisement to the server 10 via the communication I/F 22.

In operation S150, Upon receiving the advertisement change request information from the terminal 20 via the communication I/F 14, the controller 11 of the server 10 performs itinerary overview change processing. Specifically, for example, based on advertisement identification information included in the advertisement change request information, the service-related database 157 is searched for services in the same category as the service corresponding to the advertisement for which the change request has been made (i.e., searches for advertisements for food and drink services if the change request is made for an advertisement for a food and drink service, or advertisements for accommodation services if the change request is made for an advertisement for an accommodation service) in the same district or region. Then, the itinerary and the advertisement to be associated therewith are changed based on the search result.

This procedure is one example, and there may be cases in which a part of the itinerary is changed or the entire itinerary is changed.

Next, in operation S160, the controller 11 of the server 10 transmits information about the changed itinerary and information about the advertisement associated with the changed itinerary to the terminal 20 via the communication I/F 14.

In operation A170, upon receiving the above information from the server 10 via the communication I/F 22, the controller 21 of the terminal 20 causes the display 24 to display the changed itinerary and the changed advertisement information. The controller 21 of the terminal 20 then returns the processing to A130.

If it is determined in A150 that no user input for changing an advertisement relating to a service has been made (A150: NO), the controller 21 of the terminal 20 determines whether to end the processing (A190).

If it is determined that the processing continues (A190: NO), for example, the controller 21 of the terminal 20 returns the processing to A130. If it is determined that the processing ends (A190: YES), the controller 21 ends the processing.

After S160, the controller 11 of the server 10 determines whether to end the processing (S190).

If it is determined that the processing continues (S190: NO), for example, the controller 11 of the server 10 returns the processing to S140. If it is determined that the processing ends (S190: YES), the controller 11 ends the processing.

### Effects of the Example Embodiment

According to an example embodiment, the terminal 20 causes the display 24 to display an itinerary and an object (e.g., an advertisement) related to a service (e.g., a facility use service) based on the itinerary, using a chat application (e.g., a messaging application). Based on an input made to the object by the user of the terminal 20, the service is reserved through a reservation service linked to a chat service of the chat application. The chat application causes the display 24 to display reservation information regarding the reservation of the service made through the reservation service.

The service can thus be reserved through the reservation service linked to the chat service, and the user of the terminal can confirm the reservation information.

The itinerary may be generated by the chat application as a result of the user of the terminal 20 having a conversation with a chatbot.

With this, an itinerary can be easily generated by having a conversation with the chatbot.

The reservation information may include information (e.g., a URL of a reservation completion page) for causing the display 24 of the terminal 20 to display the reservation completion page for the service in the reservation service.

This causes the screen to transition to the reservation completion page for the service in the reservation service, and enables the user of the terminal to browse the reservation completion page.

The display 24 of the terminal 20 may display objects related to a plurality of various services retrieved based on the itinerary, including a first object (e.g., a sponsored advertisement) related to a first service (e.g., a service provided by a sponsor service provider) provided by a sponsor (e.g., a sponsor service provider) of the chat service. Based on an input made to the first object by the user of the terminal 20, the display 24 may display the reservation information based on the first service having been reserved through a reservation service linked to the chat service of the chat application.

This enables the user of the terminal to reference the objects related to a plurality of various services retrieved based on the itinerary, including the first object related to the first service provided by a sponsor of the chat service, and to select a service that the user wants to use. Further, based on an input made to the first object related to the first service by the user of the terminal, the first service can be reserved through a reservation service linked to the chat service of the chat application, and the user of the terminal can confirm the reservation information.

In this case, the reservation information may include information indicating that the cost of the first service has been reduced.

The cost of the first service is reduced by reserving the first service in the reservation service linked with the chat service, which is advantageous for the user of the terminal. Also, the user can be aware that the cost has been reduced.

An object (e.g., an advertisement) related to a service based on an itinerary may be displayed in an itinerary display area.

This allows the user to easily understand the correspondence relationship between the itinerary and the object related to the service based on the itinerary.

An object (e.g., an advertisement) related to a service based on an itinerary may be displayed outside an itinerary display area.

This can improve the visibility of both the itinerary and the object related to the service based on the itinerary.

When the itinerary is a first itinerary, the object is a first object (e.g., an advertisement for “XXX Hotel”), and the first itinerary and the first object are changed based on an input for changing the first object that is made by the user of the terminal 20, the terminal 20 may cause the display 24 to display a second itinerary, which is the changed first itinerary, and a second object (e.g., an advertisement for “YYY ryokan”), which is the changed first object.

This enables the user of the terminal to change the first itinerary and the first object by making an input for changing the first object, and to confirm the second itinerary after the change and the second object after the change.

In this case, the first object may be a first advertisement, and the second object may be a second advertisement different from the first advertisement.

Thus, the user of the terminal can change the first itinerary and the first advertisement by making an input for changing the first advertisement, and can confirm a second itinerary after the change and the second advertisement after the change.

According to an example embodiment, the integration of itinerary generation and service reservation within a single chat application talk room provides technical improvements in user interface efficiency and system resource utilization. By generating the itinerary through real-time conversational interactions with a chatbot using a question answering model, the system reduces the need for multiple separate applications or browser sessions, thereby minimizing context switching and lowering computational overhead on the terminal device. This seamless workflow, where objects related to services are displayed inline with the itinerary and reservations are processed via linked services without exiting the chat interface, enhances data flow between the terminal and server, enabling faster response times and more efficient network communication.

Furthermore, the ability to dynamically change itineraries and associated objects based on user inputs, while maintaining reserved states through flags or automatic cancellations, improves the adaptability of the system to real-time changes in external factors such as service availability. This technical enhancement ensures data consistency across the chat application and linked reservation services, reducing errors in reservation processing.

### First Variation of the Example Embodiment

In the case where the account linkage processing is performed in the above example embodiment, the server 10 may generate, after performing the account linkage processing, account linkage completion information (e.g., an account linkage completion content item) indicating the completion of the account linkage and transmit it to the terminal 20.

The account linkage completion information may include, for example, information indicating the completion of the account linkage, details of the account linkage, and the like.

These pieces of information may be displayed, for example, in the aforementioned talk room in which the itinerary is displayed (i.e., the talk room that includes the user of the terminal 20 and the chatbot).

However, without limitation thereto, the information may be displayed in a talk room different from the talk room in which the itinerary is displayed, or in another page of the messaging application.

### Second Variation of the Example Embodiment

In the above example embodiment, an object related to a service based on an itinerary is an advertisement, but there is no limitation to this. For example, the object may be a non-advertising introduction content item, such as an article, a column, or an image (still image or moving image) that introduces a facility use service.

For example, an advertisement may be displayed as an object related to a service based on an itinerary before a change is made, and an introduction content item related to a relevant service may be displayed after the change is made.

Specifically, for example, when the user taps the “change” button BT1 on the advertisement for “XXX hotel” in the example display screen in FIG. 7, an introduction content item for “YYY ryokan” may be displayed.

Note that different objects for the same facility use service may be displayed.

For example, in addition to the “change” button BT1, for example, an “introduction” button may be displayed in association with the advertisement in the above example display screen. When, for example, the user taps the “introduction” button on the advertisement for “XXX hotel” in the example display screen in FIG. 7, an introduction content item for “XXX hotel” may be displayed.

Conversely, a non-advertisement object may be displayed before a change is made, and an advertisement may be displayed after the change is made.

This variation adopts a configuration in which an object related to a service based on an itinerary is not an advertisement.

This enables the user of the terminal to reserve a service by making an input to a non-advertisement object related to the service based on a displayed itinerary.

In this case, the first object may be a first advertisement, and the second object may be a non-advertisement object.

This enables the user of the terminal to change the first itinerary and the first advertisement by making an input for changing the first advertisement, and to confirm a second itinerary after the change and a second non-advertisement object after the change.

### Third Variation of the Example Embodiment

In a case where an itinerary is changed by changing an advertisement in the above example embodiment,
(1) for example, when an accommodation facility (a second service corresponding to a second object) is to be changed after a reservation of an eating establishment (a service corresponding to a first object) has been completed, it is possible that the entire itinerary is changed (regenerated) due to a change operation performed on the second object. However, the first object for which the reservation has been completed may be kept unchanged, and the reserved state thereof may also be continued.

That is to say, only an object for which a reservation has not been completed can be changed, and the reserved state is not changed. Thus, the itinerary may be changeable based on the determined itinerary.

In this case, for example, in the reservation processing in S140 within the processing in FIG. 9, the controller 11 of the server 10 completes a reservation of a service (e.g., a food and beverage service) corresponding to a first object (e.g., an advertisement corresponding to the food and beverage service) associated with the itinerary overview information, and then stores reservation information about the service corresponding to the first object, in association with the account of the user A.A. Further, the controller 11 of the server 10 sets an unchangeability flag in association with the first object (or the service corresponding to the first object), for example.

Further, for example, upon receiving advertisement change request information for changing an advertisement for a service (e.g., an accommodation service) based on an itinerary from the terminal 20, in the itinerary overview change processing in S150, the controller 11 of the server 10 references the stored reservation information to change the itinerary overview information, and changes a second object (e.g., an advertisement corresponding to an accommodation service) to a third object (e.g., an advertisement corresponding to another accommodation service).

Note that, after the reservation processing in S140, the controller 11 of the server 10 may transmit to the terminal 20, object unchangeability information indicating that the first object cannot be changed. If it is determined that a user input for changing the first object has been made (A150: Yes), the controller 21 of the terminal 20 may cause the display 24 to display the object unchangeability information.

Also, if it is determined that a user input for changing the first object has been made (A150: Yes), the controller 21 of the terminal 20 transmits advertisement change request information to the server 10 (A160). The controller 11 of the server 10 may then transmit the object unchangeability information to the terminal 20, and the terminal 20 may cause the display 24 to display the received object unchangeability information.

Instead of the first object, the aforementioned reservation completion content item may be associated with the changed itinerary.

In this case, for example, upon receiving advertisement change request information for changing an advertisement for a service (e.g., an accommodation service) based on an itinerary from the terminal 20, in the itinerary overview change processing in S150, the controller 11 of the server 10 changes the itinerary overview information, changes the first object to be associated to the reservation completion content item, and changes a second object to be associated (e.g., an advertisement corresponding to an accommodation service) to a third object (e.g., an advertisement corresponding to another accommodation service).

Meanwhile, (2) even when an operation for changing the second object is performed, as opposed to (1) above, the first object may be changeable, and the reservation for the service corresponding to the first object may be automatically canceled.

In this case, for example, upon receiving advertisement change request information for changing an advertisement for a service (e.g., an accommodation service) based on an itinerary from the terminal 20, in the itinerary overview change processing in S150, the controller 11 of the server 10 changes the itinerary overview information, changes the first object to be associated to a reservation completion content item, and changes a second object to be associated (e.g., an advertisement corresponding to an accommodation service) to a third object (e.g., an advertisement corresponding to another accommodation service). Further, the controller 11 of the server 10 deletes the reservation information regarding the service corresponding to the first object that has been stored previously.

In this case, for example, a message such as “Would you like to cancel the reservation for the eating establishment?” may be displayed on the terminal 20. For example, the reservation may be automatically canceled, for example, if the user selects “Yes”, without performing an operation to cancel the reservation in the reservation service. Meanwhile, the reserved state may be continued in the reservation service, and only the second object may be changed if the user selects “No”.

This saves time and effort when canceling a reservation.

### Fourth Variation of the Example Embodiment

In the above example embodiment, the display 24 of the terminal 20 may display an itinerary in map form, and an object related to a service may be displayed on the map (e.g., an advertisement or the like may be displayed in association with a service providing place on the map). Further, an object related to a service may be displayed separately from the map.

### Fifth Variation of the Example Embodiment

In the above example embodiment, for a service based on an itinerary (a facility use service, a transportation facility use service, etc.), a configuration may be used in which, when the user of the terminal 20 makes a user input for requesting bulk reservation to the terminal 20, bulk reservation request information is transmitted from the terminal 20 to the server 10, and the server 10 performs bulk reservation processing for reserving all reservable services based on the itinerary, or for some (two or more) of these services in bulk.

### Other Example Embodiments

The above example embodiment and variations have illustrated a technique of implementing example embodiments in a chat service including a messaging service. However, without limitation thereto, the same technique may be applied similarly to anything other than a chat service.

In the case where the example embodiments is implemented in a chat service, the various content items described in the above example embodiment need not necessarily be displayed in a chat room. Further, the information displayed in a chat room in the above example embodiment may be displayed on a screen or a page other than a chat room on the chat application.

The terminal 20 may perform at least part of the processing that is performed by the server 10 in the above-described example embodiment and variations. Conversely, the server 10 may perform at least part of the processing that is performed by the terminal 20 in the above example embodiment.

In this case, the processing described in the example embodiment may be implemented by a single server or distributed in a server system constituted by a plurality of servers.

Note that, for example, a system constituted by one or more servers may be defined as a server system, and a server may include a server system.

In the above example embodiment and variations, the server for distributing various applications (the server from which the terminal 20 downloads the applications) may be a server that is different from the server or the like that provides corresponding services (applications). That is, a server for delivering the applications and a server or the like that performs application management processing or the like described in the above example embodiment and variations may be configured as physically separated servers or as a single server.

The applications are not limited to including programs for various applications, but may also include, for example, programs that provide the functionality of another service as one function of a primary application (e.g., a program that provides the functionality of an advertisement distribution service as one function of the messaging application, or vice versa), and programs for updating the primary application. The programs may also include data utilized in the application programs (including data for updating the applications, etc.).

Furthermore, in the above example embodiment and variations, for example, a method for implementing the example embodiments using a client-server system has been described, but the example embodiments are not limited to this. As mentioned above, the example embodiments may also be implemented by a system such as a distributed system in which the terminal 20 has the functions of a server or server system. For example, the terminal may perform the processing that is described as being performed by the server or the server system according to the flowcharts described in the above example embodiment.

As discussed above, in one or more example embodiments, a communication system 1 integrates itinerary generation, service discovery, and reservations seamlessly within a single chat application, enabling users to converse with a chatbot to create a personalized itinerary and interact with related service objects, such as advertisements or links, directly in the chat interface. This unified system allows reservations to be made through linked services without exiting the chat application, displaying confirmation information inline, which solves the conventional problems by minimizing app-switching, reducing computational overhead through efficient in-app processing, and enhancing convenience with faster, more intuitive interactions that streamline the entire travel planning and booking experience.

As mentioned above, the content described in the above example embodiment, variations, and other examples may be applied in combination with each other.

Any functional blocks shown in the figures and described above, such as the functional blocks included in the server 10 and terminal 20, may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

It should be understood that example embodiments described herein should be considered in a descriptive sense only and not for purposes of limitation. While some example embodiments have been particularly shown and described, it will be understood by one of ordinary skill in the art that variations in form and detail may be made therein without departing from the spirit and scope of the claims.

What is claimed is:

1. A non-transitory computer readable medium storing a program that, when executed by a terminal, causes the terminal to:
display, within a chat application displayed on the terminal, an itinerary and an object related to a service based on the itinerary, wherein the object includes a link to a page integrated within the chat application that facilitates a reservation service; and
display, within the chat application, reservation information regarding a reservation of the service made by a user of the terminal through the reservation service on the display.

2. The non-transitory computer readable medium storing the program according to claim 1, wherein the program, when executed, further causes the terminal to:
instruct a server to generate the itinerary based on a conversation within a talk room of the chat application between the user of the terminal and a chatbot; and
receive the itinerary from the server communicatively coupled to the terminal.

3. The non-transitory computer readable medium storing the program according to claim 1, wherein the terminal is configured to generate the reservation information such that the reservation information includes a reservation completion page integrated within the chat application, the reservation completion page indicating that the reservation of the service is complete.

4. The non-transitory computer readable medium storing the program according to claim 1, wherein the program, when executed by the terminal, further causes the terminal to:
retrieve objects respectively related to a plurality of services based on the itinerary, the objects including a first object related to a first service provided by a sponsor, and
display the reservation information on the display based on the first service being reserved through the reservation service based on an input made with respect to the first object by the user of the terminal.

5. The non-transitory computer readable medium storing the program according to claim 4,
wherein the reservation information includes information indicating that a cost of the first service has been reduced.

6. The non-transitory computer readable medium storing the program according to claim 1,
wherein the object is displayed inside or outside a display area for the itinerary.

7. The non-transitory computer readable medium storing the program according to claim 6, wherein the itinerary is a first itinerary and the object is a first object, and wherein the program, when executed by the terminal, further causes the terminal to:
change the first itinerary to a second itinerary and the first object to a second object based on an input for changing the first object made by the user of the terminal, and
display, within the chat application on the display, the second itinerary, and the second object.

8. The non-transitory computer readable medium storing the program according to claim 7,
wherein the first object is a first advertisement, and
the second object is a second advertisement different from the first advertisement, or a non-advertisement object.

9. The non-transitory computer readable medium storing the program according to claim 7, wherein the program, when executed by the terminal, further causes the terminal to:
transmit, to a server communicatively coupled to the terminal, a change request based on the input for changing the first object; and
receive, from the server, the second itinerary and the second object, in response to transmitting the change request.

10. The non-transitory computer readable medium storing the program according to claim 9, wherein the server changes the first itinerary to the second itinerary while maintaining the reservation of the service based on an unchangeability flag being set for the service.

11. The non-transitory computer readable medium storing the program according to claim 1, wherein the program, when executed by the terminal, further causes the terminal to:
display the itinerary on a map within a talk room; and
display the object related to the service on the map.

12. The non-transitory computer readable medium storing the program according to claim 1, wherein the program, when executed by the terminal, further causes the terminal to:
perform account linkage processing to link an account of the user in the chat application with an account of the user in the reservation service; and
display, within the chat application, account linkage completion information indicating completion of the account linkage.

13. The non-transitory computer readable medium storing the program according to claim 12, wherein the program, when executed by the terminal, further causes the terminal to:
perform the reservation using the account linked to the reservation service without transitioning to an external application.

14. The non-transitory computer readable medium storing the program according to claim 12, wherein the program, when executed by the terminal, further causes the terminal to:
calculate a position of the terminal using a position detector; and
transmit the position of the terminal to a server such that the itinerary is tailored to the position of the terminal.

15. An information processing method performed by a terminal, the method comprising:
displaying, within a chat application displayed on the terminal, an itinerary and an object related to a service based on the itinerary, wherein the object includes a link to a page integrated within the chat application that facilitates a reservation service; and
displaying, within the chat application, reservation information regarding a reservation of the service made by a user of the terminal through the reservation service.

16. A terminal, comprising:
a display; and
a processor and a memory storing a program that, when executed by the processor, causes the terminal to:
display, within a chat application displayed on the display, an itinerary and an object related to a service based on the itinerary, wherein the object includes a link to a page integrated within the chat application that facilitates a reservation service, and
display, within the chat application, reservation information regarding a reservation of the service made by a user of the terminal through the reservation service.
